(19) United States
(12) Patent Application Publication
(10) Pub. No.: US 2004/0248647 A1
(43) Pub. Date: Dec. 9, 2004

(54) Gaming machine with alterable display feature

(76) Inventors: Wayne H. Rothschild, Northbrook, IL (US); Alfred Thomas, Las Vegas, NV (US)

Correspondence Address: JENKENS & GILCHRIST, P.C., 225 WEST WASHINGTON, SUITE 2600, CHICAGO, IL, 60606, US

(21) Appl. No.: 10/681,907

(22) Filed: Oct. 9, 2003

Related U.S. Application Data
(63) Continuation-in-part of application No. 10/457,629, filed on Jun. 9, 2003.

(51) Int. Cl. A63F 13/00

(52) U.S. Cl. 463/30

(57) ABSTRACT

A gaming machine for conducting a wagering game includes a game display and an alterable display mechanism. The game display is for displaying the wagering game. The alterable display portrays a mechanical display member movable between a first position and a second position. The display member displays first and second information to a player when in the respective first and second positions. The information may be signage information that is free of random events and outcomes associated with the wagering game. The display member may, for example, be a flexible member scrolled about rollers, a rotatable panel, a rotatable set of panels akin to shutters, a “plate” rotatable in a fashion similar to a phonographic turntable with dividers to separate the sides, or a video representation of any of the foregoing.

### REFERENCE TO RELATED APPLICATIONS

This application is a continuation-in-part of U.S. application Ser. No. 10/457,629 entitled “Gaming Machine With Alterable Display Mechanism,” filed Jun. 9, 2003, and incorporated herein by reference in its entirety.

### FIELD OF THE INVENTION

The present invention relates generally to gaming machines and, more particularly, to a gaming machine including a dynamically alterable display feature.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator. Accordingly, in the competitive gaming machine industry, there is a continuing need for gaming machine manufacturers to produce new types of games, or enhancements to existing games that will attract frequent play by enhancing the entertainment value and excitement associated with the game. Another aspect of increasing game play is the ability to place games at “ideal” locations during “ideal” playing times.

Gaming machines display a variety of information. Methods used to display information on gaming machines include fixed, permanently printed, top and/or belly glass, or primary and/or secondary video displays. Information may, for example, include billboard information, product or service advertisements, player attraction material, pay tables (e.g., within a single game or for different games available via a multi-game machine), bonusing information, game help information, game play instructions, variable themes associated with a particular casino or gaming machine, and combinations thereof. With the complexity of the games increasing to satisfy player and casino demands, fixed, permanent glass displays limit the amount of information that can be displayed.

Traditional slot-based game players who developed their appreciation of the games on mechanically driven machines, have started to adopt the newer, video slot machines. Video-based slot machines offer a mechanical “feel” with the visual representation of a spinning reel and the accompanying audio sounds, all displayed with animation on a video screen. Both mechanical and video-based slot machines offer bonus games or increased win amounts based on the results of a play of the game. In many games, a secondary display is needed to present information either vital to the play of the game or necessary to the player in the attempt to understand the results. The secondary display can take on a variety of form factors and is an excellent medium to present pay tables and variants if offered for a particular game. In keeping with the traditional “feel” of the slot-based gaming machine, a mechanically driven or mechanically inspired top box display would enhance the entertainment of the player and offer the ability to alter information if required by the game.

### SUMMARY OF THE INVENTION

In accordance with the foregoing, a gaming machine for conducting a wagering game includes a game display and a secondary alterable mechanical or mechanically inspired video display. The game display is for displaying the wagering game. The secondary display may be a mechanical display or a video display (such as an LCD, CRT, or plasma screen). The secondary display portrays a display member movable between a first position and a second position. The display member displays first and second information to a player when in the respective first and second positions. The information may be signage information that is free of random events and outcomes associated with the wagering game. The information may, for example, include billboard information, advertisement information, player attraction material, pay table information, bonusing information, game help information, game play instructions, thematic models and/or artwork, and combinations thereof. The display member may, for example, be a flexible member scrolled about rollers, a rotatable panel, a rotatable set of panels akin to shutters, a “plate” rotatable in a fashion similar to a phonographic turntable with dividers to separate the sides, or a video representation of any of the foregoing mechanical devices.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

The foregoing and other advantages of the invention will become apparent upon reading the following detailed description and upon reference to the drawings in which:

FIG. 1 is a front view of a gaming machine embodying the present invention;

FIG. 2 is a block diagram of the control mechanism used for communication between interface components, the main processor, and the display units;

FIG. 3 is an enlarged front view of an alterable display mechanism of the gaming machine;

FIG. 4 is a front view of the display mechanism depicting a scrolling operation in progress;

FIG. 5 is a front view of the display mechanism depicting an altered bonus pay table (2×);

FIG. 6 is a front view of the display mechanism depicting an altered bonus pay table (5×);

FIG. 7 is a perspective view of an alterable display scroll mechanism containing two rollers and associated gear mechanisms;

FIG. 8 is a perspective view of an alterable two-position panel display mechanism rotatable about a horizontal axis;

FIG. 9 is a perspective view of an alterable two-position shutter display mechanism with panels rotatable about horizontal axes;

FIG. 10 is a top view of a two-position rotatable display mechanism depicting a configuration suited for signage information and/or “toy” display;

FIG. 11 is a top view of a four-position rotatable display mechanism depicting a configuration suited for signage information and/or “toy” display;

FIG. 12 is a detailed view of the two-position rotatable display mechanism including a stepper motor and gearing.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

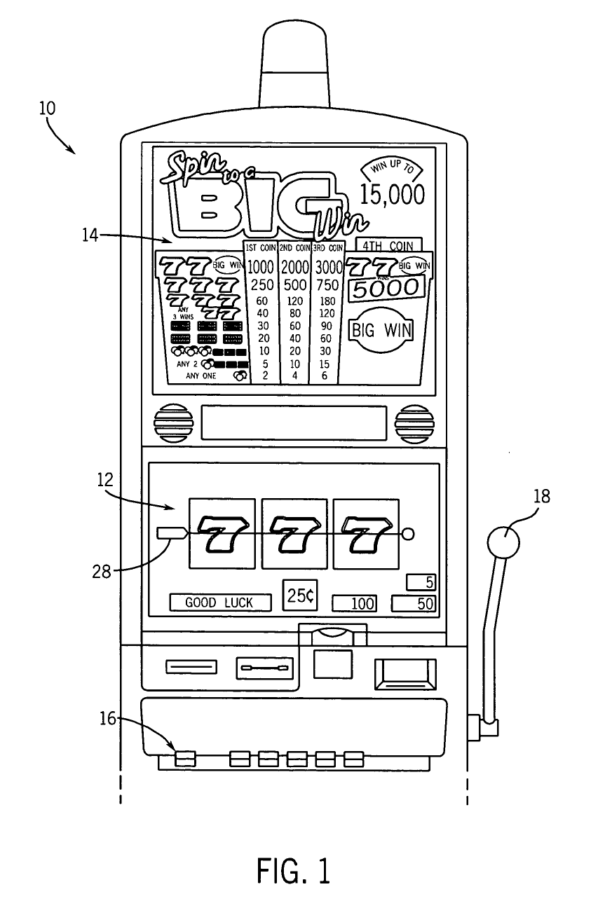

FIG. 1 depicts a gaming machine 10 operable to conduct a wagering game such as reel slots (mechanical or video), poker, keno, bingo, blackjack, or roulette. In operation, the gaming machine receives a wager from a player to purchase a “play” of the game. In a play of the game, the gaming machine generates at least one random event using a random number generator (RNG) and provides an award to the player for a winning outcome of the random event. Alternatively, the random event may be generated remotely at a remote computer. The remote computer may use either an RNG or pooling schema for its central determination of a game outcome. To portray the random event and outcome to the player, the gaming machine includes a primary display 12. If the wagering game is a reel slot game, for example, the primary display 12 includes a plurality of symbol-bearing reels that are rotated and stopped to place symbols on the reels in visual association with a pay line 28.

In addition to primary display 12, the gaming machine 10 includes an alterable display mechanism 14 for displaying signage information. By definition, the signage information does not portray the random events or outcome of the wagering game. Signage information may, for example, include billboard information, product or service advertisements, player attraction material, pay tables (e.g., within a single game or for different games available via a multi-game machine), bonusing information, game help information, game play instructions, variable themes associated with a particular casino or gaming machine, and combinations thereof. The signage display 14 may serve as a substitute for displaying some or all of the information currently provided on the top glass or belly glass of a conventional slot machine.

The primary display 12 may be implemented with a CRT, LCD, plasma, mechanical reels (in the case of a reel slot game), or other type of display known in the art. The primary display 12, especially if implemented in video, may be overlaid with a touch screen to facilitate interaction with the player. In the illustrated embodiment, the gaming machine 10 is an “upright” version in which the primary display 12 is oriented vertically relative to the player. Alternatively, the gaming machine may be a “slant-top” version in which the primary display 12 is slanted at about a thirty-degree angle toward the player of the gaming machine 10.

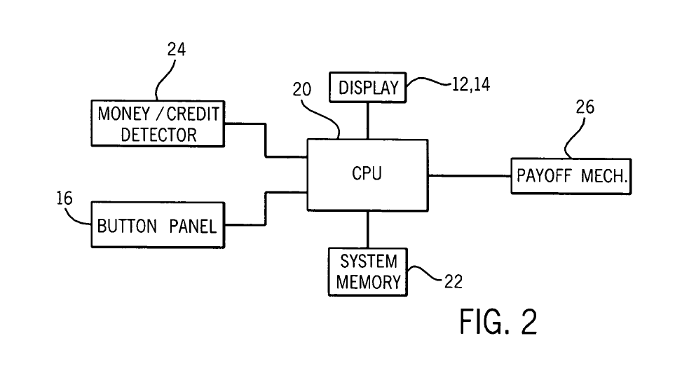

FIG. 2 is a block diagram of a control system suitable for operating the gaming machine. Money/credit detector 24 signals a central processing unit (CPU) 20 when a player has inserted money or played a number of credits. The money may be provided by coins, bills, tickets, coupons, cards, etc. Using a button panel 16 the player may select any variables associated with the wagering game and place his/her wager to purchase a play of the game. In a play of the game, the CPU 20 generates at least one random event using a random number generator (RNG) and provides an award to the player for a winning outcome of the random event. The CPU 20 operates the primary display 12 to represent the random event(s) and outcome(s) in a visual form that can be understood by the player. In addition to the CPU 20, the control system may include one or more additional slave control units for operating one or more of the displays 12 and 14.

System memory 22 stores control software, operational instructions and data associated with the gaming machine. In one embodiment, the system memory 22 comprises a separate read-only memory (ROM) and battery-backed random-access memory (RAM). However, it will be appreciated that the system memory 22 may be implemented on any of several alternative types of memory structures or may be implemented on a single memory structure. A payoff mechanism 26 is operable in response to instructions from the CPU 20 to award a payoff to the player. The payoff may, for example, be in the form of a number of credits. The number of credits is determined by one or more math tables stored in the system memory 22.

One example of the use of the alterable display mechanism 14 is in connection with a slot-based wagering game including a basic three-reel mechanical, single pay line, slot game with a top box display feature. The alterable display mechanism 14 (included in the top box in this example) is triggered by a start-bonus outcome in the basic slot game. Referring to FIG. 1, to play the basic slot game, a player places a wager using the button panel 16. In response to pressing the “spin reels” button, the CPU spins and randomly stops the plurality of symbol-bearing reels on the primary display 12 to place symbols on the reels in visual association with the pay line 28. Other mechanisms, such as a handle 18, may be used to set the reels in motion. The number of illustrated reels is three but a different number of reels may be provided if desired. The display 12 on which the reels are implemented may be mechanical or video. If the display 12 is mechanical, the reels are physical and rotatably driven by stepper motors. If, however, the display 12 is video, the reels are simulated with moving graphics.

The CPU uses a random number generator to select a game outcome (e.g., “basic” game outcome) corresponding to a particular set of reel “stop positions.” The CPU then causes each of the reels to stop at the appropriate stop position. Symbols are displayed on the reels to graphically illustrate the reel stop positions and indicate whether the stop positions of the reels represent a winning game outcome.

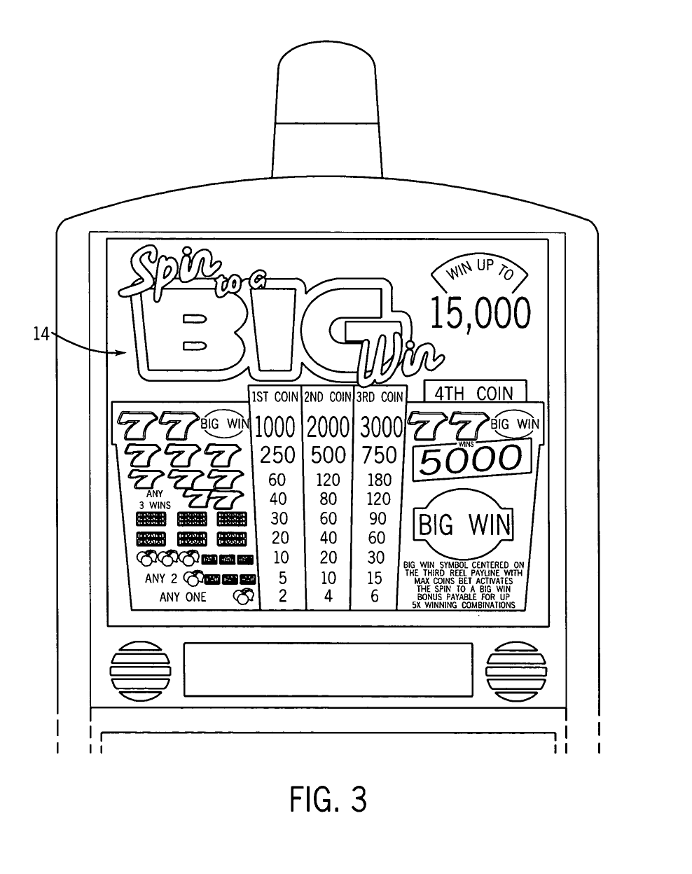

Winning basic game outcomes (e.g., symbol combinations resulting in payment of coins or credits) are identifiable to the player by a pay table. The pay table is printed on the alterable display mechanism 14 as best shown in FIG. 3. A winning basic game outcome occurs when the symbols appearing on the reels along the pay line 28 correspond to one of the winning combinations on the pay table. A winning combination, for example, could be three matching symbols along the pay line 28, where the award is greater as the number of matching symbols along the pay line 28 increases. If the displayed symbols stop in a winning combination, the game credits the player an amount corresponding to the award in the pay table for that combination multiplied by the number of wagered credits. The player may collect the amount of accumulated credits by pressing a “Collect” key on the button panel 16.

Included among the plurality of basic game outcomes is a start-bonus outcome for triggering play of a bonus event. The start-bonus outcome may occur when a special start-bonus symbol or a special combination of symbols appears on one or more of the reels. The appearance of the start-bonus outcome causes the CPU to shift operation from the basic slot game to the bonus event. In the illustrated example, the start-bonus outcome consists of a special “Big Win” bonus symbol along the pay line 28.

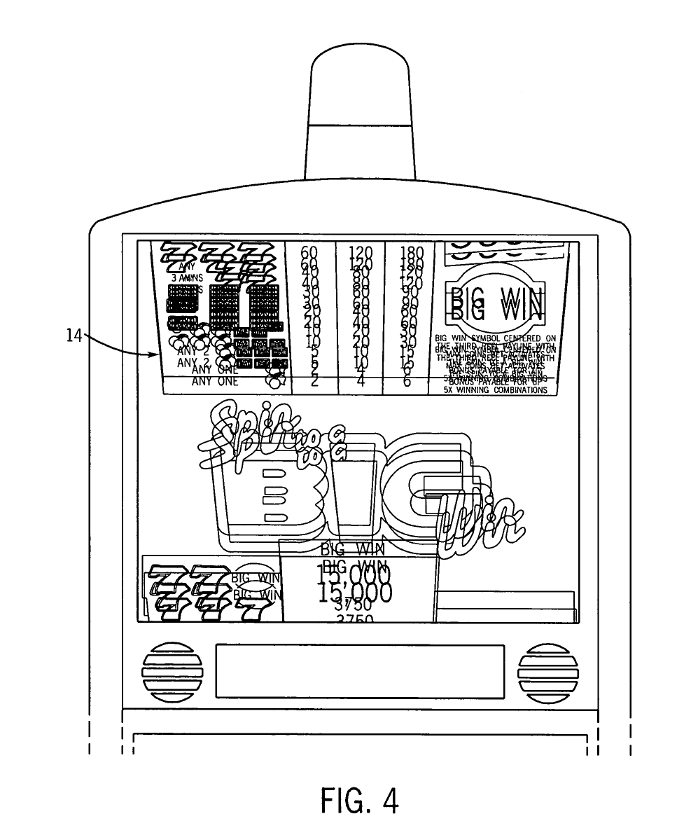

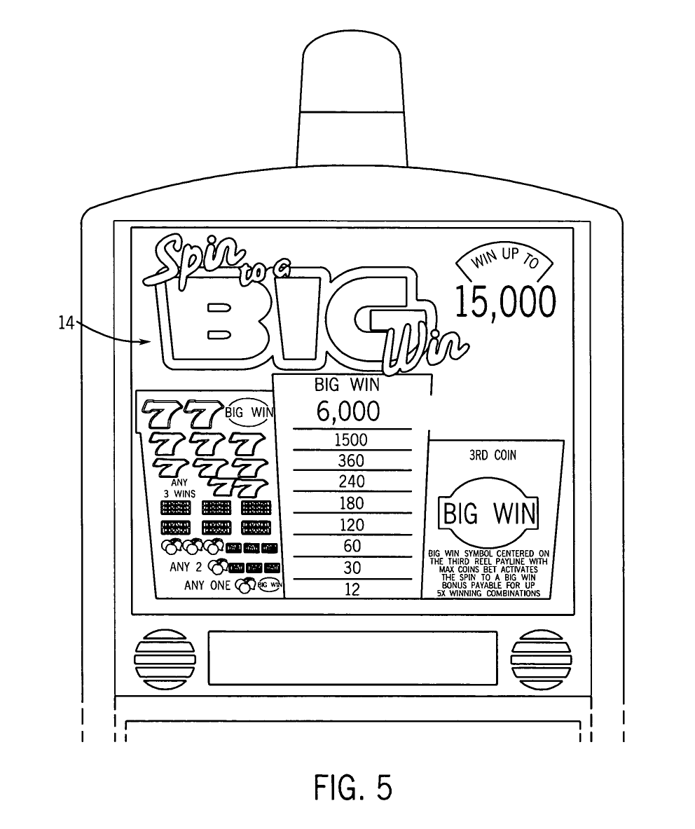

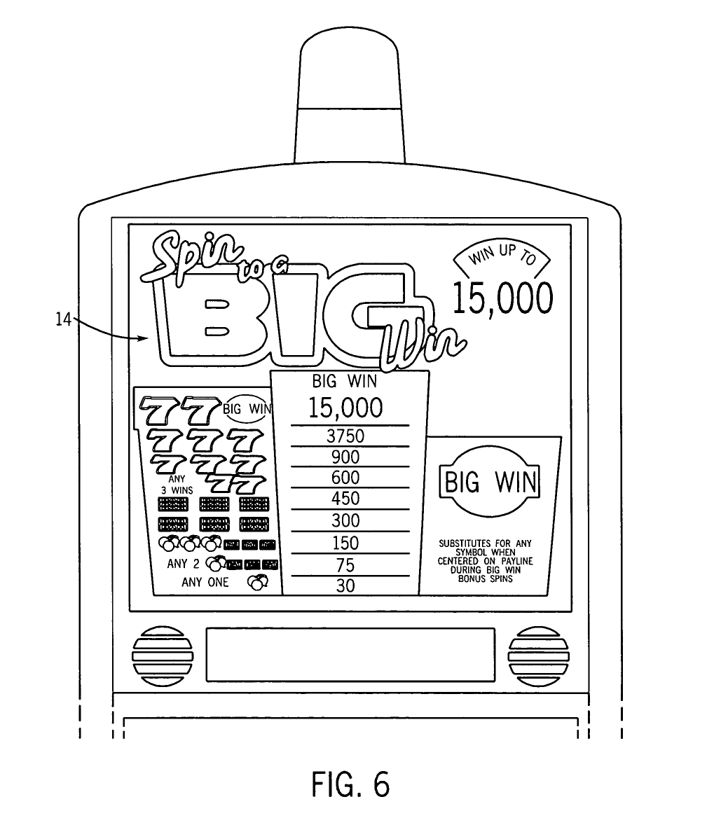

FIGS. 3, 4, 5, and 6 depict one possible sequence of displayed media. FIG. 3 shows the basic pay table displayed on the alterable display mechanism 14 during the basic slot game. If the start-bonus outcome is displayed on the primary display 12 during the basic slot game (see FIG. 1), a bonus event is triggered and the basic pay table begins to “scroll” (FIG. 4). The alterable display mechanism 14 may move to a predetermined pay table based on the symbols displayed on the reels or may move in a random fashion. FIG. 5 is an example of a bonus pay table that multiplies the 3^{rd} coin pays of the basic pay table by two (2×). FIG. 6 is an example of a bonus pay table that multiplies the 3^{rd} coin pays of the basic pay table by five (5×). The reels spin and if they stop on a winning combination, the bonus event awards a payoff based on the currently displayed bonus pay table. If the reels stop on a losing combination, the reels re-spin until a winning combination occurs. The CPU then shifts operation from the bonus event back to the basic slot game, causing the alterable display mechanism 14 to scroll back to the basic pay table in FIG. 3.

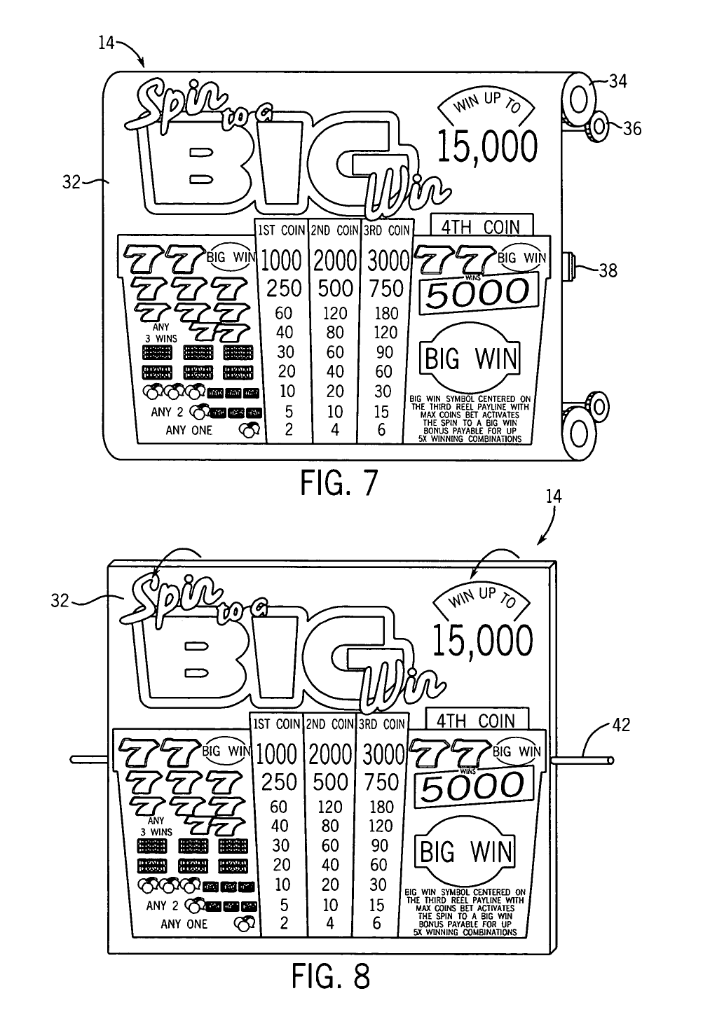

FIG. 7 contains a perspective view of a scrolling device used as the alterable display mechanism 14 of the gaming machine. The device includes a flexible sheet/display member 32 containing multiple images. This display member 32 is affixed to supply/take-up rollers 34 that are driven by gearing 36 attached to a single or multiple stepper motors. These motors are connected to a controller that, in turn, communicates with the main CPU for instructions. An optical sensor 38 is used to maintain correct positioning of the scrolling display member 32. The display member 32 can be lit in any number of ways including back lighting.

FIG. 8 is a perspective view of a rotating panel device used as the alterable display mechanism 14 of the gaming machine. The rotating panel device includes a single rigid panel 44 containing images (e.g., different pay tables) on opposite sides thereof. The panel 44 rotates on a centrally located pivot rod 42 mounted on the horizontal. The rotating panel 44 may be turned using methods such as a stepper motor driving gears, a chain, or a belt. In any case, a controller interfaces between the motor and the CPU.

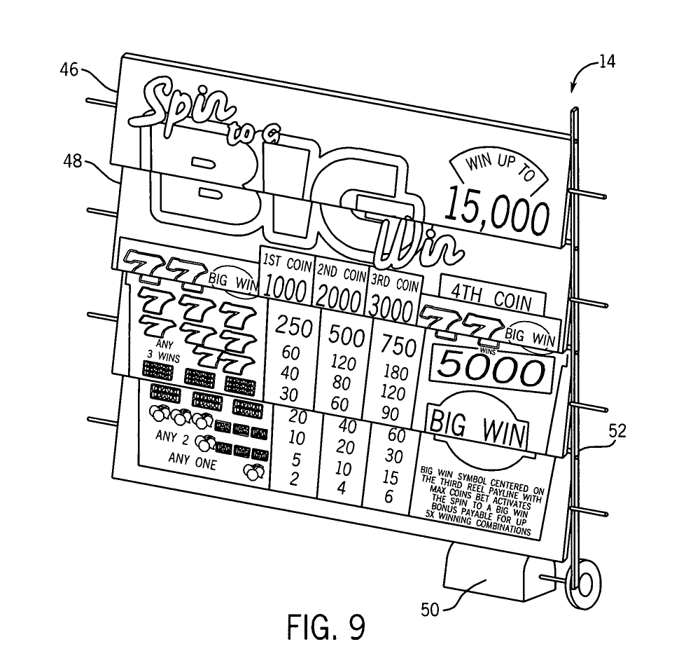

FIG. 9 is a perspective view of a rotating shutter device used as the alterable display mechanism 14 of the gaming machine. The rotating shutter device includes a plurality of parallel panels 46 containing images on opposite sides thereof. The first sides of the respective panels 46 collectively depict a first image (e.g., first pay table), while the second sides of the respective panels 46 collectively depict a second image (e.g., second pay table). The panels 46 rotate on centrally located pivot rods 48 mounted on the horizontal. The rotating panels 46 may be turned using methods such as a stepper motor 50 driving a cam with a rod 52 attached to the panels 46. A controller interfaces between the motor and the CPU.

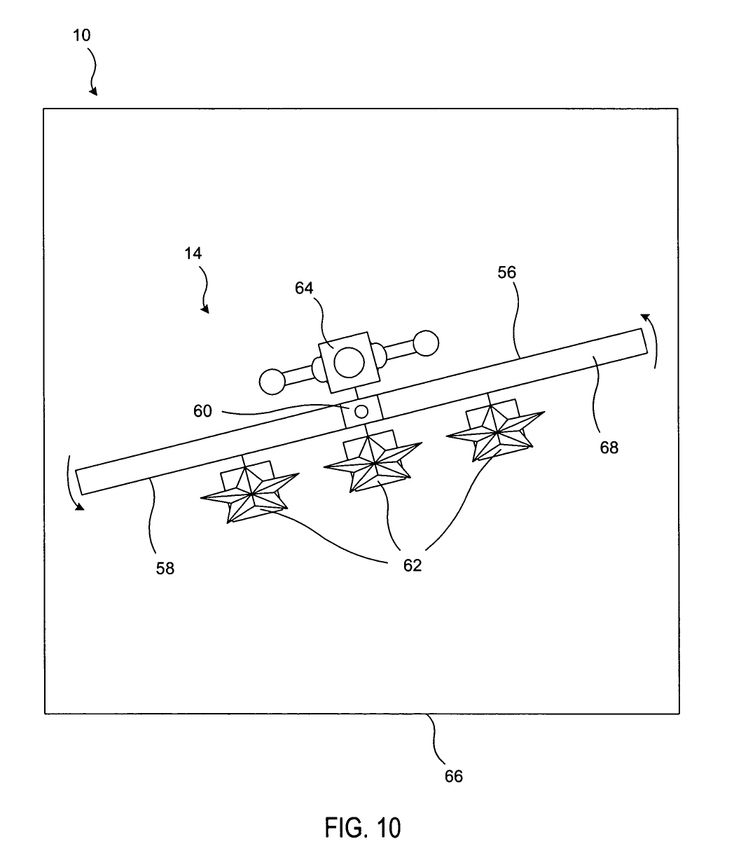

FIG. 10 is a top view of a two-sided rotatable display mechanism 14 within the gaming machine 10 which, in this example, contains a basic game play side 56 and a bonus game play side 58. Each side may contain any combination of physical elements, such as model figures, dioramas, raised surface caricatures, associated back panel display information, lights, etc. The physical elements may have two or three dimensions. The top box viewing window 66 of the gaming machine 10 allows the player to view one side of the rotatable display mechanism 14 when in a fixed, stopped position. The panel 68 allows for the presentation of a background display of the currently viewed side while preventing the viewing of the non-displayed side. The rotatable display mechanism 14 pivots around a vertical post 60 driven by any suitable electromechanical means, such as a stepper motor and controller. If a start-bonus outcome is displayed on the primary display 12 during the basic slot game (see FIG. 1), a bonus event is triggered and the rotatable display mechanism 14 in the top box area 14 rotates to display the bonus game play side 58 with model FIG. 62. If the rotatable display mechanism 14 is deployed with more than two sides, it may move to a predetermined side based on the symbols displayed on the reels or may move in a random fashion. Once the bonus game play side 58 is displayed, the reels spin and if they stop on a winning combination, the bonus event awards a payoff based on the currently displayed bonus. If the reels stop on a losing combination, the reels re-spin until a winning combination occurs. The CPU then shifts operation from the bonus event back to the basic slot game, causing the rotatable display mechanism 14 to rotate back to the basic game play side 56 (with model FIG. 64).

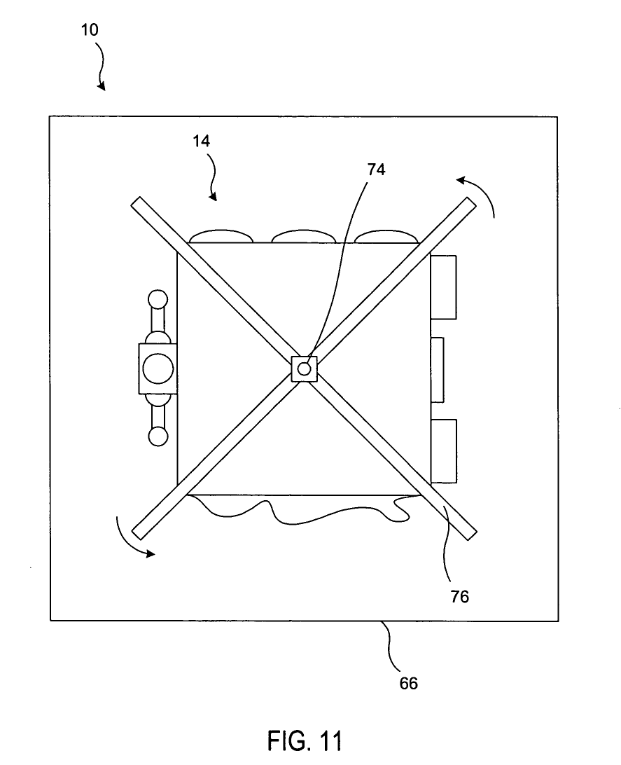

FIG. 11 is a top view of a four-sided rotatable display mechanism 14 within the gaming machine 10. In this example, the rotatable display mechanism 14 containing physical elements that present themes of four different games playable on the same gaming machine 10 separated by display panels 76. When the player chooses (via the button panel 16 or the touch screen 18) to play a different game than the one displayed on the game play display 12 (see FIG. 1), the rotatable display mechanism 14 is turned on the pivot axis 74 to display the game theme chosen. The player views the rotatable display mechanism 14 through the top box display front glass 66 of the gaming machine 10.

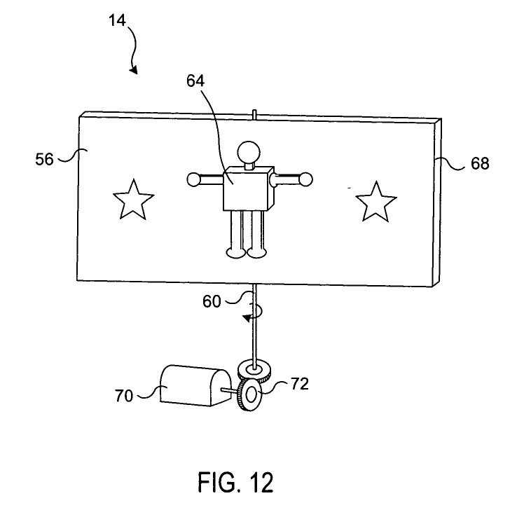

FIG. 12 is an enlarged front view of the two-position rotatable display mechanism 14 in FIG. 10. The display background 56 and the model FIG. 64 are attached to the panel 68. The panel 68 is attached to a central pivot point presented in this embodiment as a rod 60 projecting through the panel 68. In this example, the rod 60 is attached to a gearing mechanism 72 that is driven by a stepper motor 70. Alternatives to the above mentioned drive mechanism are: chain drives, belts drives, and/or gears—driven by motors or other devices capable of continuous switched activity. Alternatives to the central pivot rod 60 are a cylinder or “plate” directly attached to the motor that would revolve in a fashion similar to a phonographic turntable.

The mechanism for moving the displays 14 described above may, for example, include chain drives, belts drives, and/or gears; all driven by stepper motors or other devices capable of continuous switched activity. Depending upon the signage information depicted on the display 14, the movement may, for example, be activated by 1) pressing buttons (selecting a game in a multi-game machine), 2) certain game conditions (triggering a bonus round), or 3) automated sequencing (for advertisements).

Any of the above-noted types of alterable display mechanisms 14 may be represented on a video display. The video display depicts the mechanical movements of a scrolling or rotating device through animation. For instance, video-based slot machines create the “illusion” of an actual mechanical spinning reel which appeals to the traditional slot player while allowing the game manufacturer to enhance the effects presented on the reels, such as entertaining animated graphics in place of fixed images. This approach appeals to a younger audience who is more likely to have experienced the revolution in video presentations and computer generated graphics in the past decade. The same approach can be used on the top box scrolling display with video. Entertaining animation can be presented while the information displayed in the top box area “scrolls” to a different “page” of information. The advantages of using video to “mimic” a mechanical slot machine's movement are that the game can be changed easily via software with minimal downtime for mechanical component replacement.

While the present invention has been described with reference to one or more particular embodiments, those skilled in the art will recognize that many changes may be made thereto without departing from the spirit and scope of the present invention.

For example, in multi-game machines, pay table information may be provided on a video display screen in response to menu driven commands entered via a button panel or a touch screen. Because a video display portrays the random events and outcome of the wagering game, the pay table information generally cannot be simultaneously displayed to the player while he or she is playing one of the wagering games available on the machine. Thus, the only way to access the pay table information is through the menu when the primary game is not being played. This can be confusing or tedious to the player who may have to keep switching between screens to determine outcomes or bonusing information. In this embodiment, a separate pay table can be displayed on the alterable display mechanism 14 for each of the multiple games available on the machine. For example, if a player selected a keno game from the primary display, the pay table presented on the alterable display mechanism 14 would be for a keno game. If the player thereafter decided to play a video poker game, the pay table presented on the alterable display mechanism 14 would show the appropriate poker pay table. Thus, the present invention allows players to more easily play and understand the various games on a multi-game machine.

Furthermore, the scrolling device in FIG. 7 may be configured to scroll the display member 32 in other directions such as horizontal or diagonal. The take-up rollers 34 may be affixed in any manner that supports the mechanics of the gaming machine 10, the requirements of the display member, and/or effective viewing. Similarly, the single panel 44 of the panel device in FIG. 8 and the multiple parallel panels 46 of the shutter device in FIG. 9 may be oriented in other directions, such as horizontal or diagonal. The panels 46 may be affixed in any position to support the mechanics of the gaming machine 10, the requirements of the panels, and/or effective viewing.

The number of separately viewable sections of the flexible display member 32 of the scrolling device in FIG. 7 may vary to be two, three, or more sections, depending upon the limits of the space provided. A plurality of additional rollers 34 may be introduced to support more viewable sections.

The flexible display member 32 of the scrolling device in FIG. 7 may vary in size (height or width). The position(s) of the take-up rollers 34 may be adjustable to support automatically altering the display area. Other mechanisms may be used to modify the size of the display area such as an adjustable bezel aperture.

Although the number of alterable display mechanisms 14 employed on a single gaming machine 10 is illustrated to be one, more than one display mechanism 14 may be used on a gaming machine 10. Also, the alterable display mechanisms may be positioned in locations other than, or in addition to, the top box; for example, such a mechanism could replace the traditional belly glass of the gaming machine.

The single panel 44 of the panel device in FIG. 8 and the multiple parallel panels 46 of the shutter device in FIG. 9 may each have a number of sides corresponding to the number of images that can be presented by the gaming machine 10. For example, three-sided panels may be implemented to allow for separate display of one basic pay table and two bonus pay tables.

The scrolling device in FIG. 7 may be combined with another device, such as a bonus mechanism, positioned inside the scrolling device. The bonus mechanism may be one of the other alterable display mechanisms discussed above. The scrolling device would have a transmissive section that allows the interior bonus mechanism to be viewed by the player through such transmissive section. The transmissive section may be transparent or translucent. Both the scrolling device and the interior bonus mechanism may be operated to reveal a plurality of different combined displays. For example, in response to a start-bonus outcome in the basic game, the scrolling device could scroll to the transmissive section, and the interior bonus mechanism could rotate to any one of several sides.

While the alterable display depicted in FIGS. 3, 4, 5, and 6 depicts a pay table changing prior to the start of a bonus round, additional pay table changes could occur during the bonus round as well. For instance, the game could contain a feature that calls for the top box display area to scroll to another view, perhaps another pay table or random bonus selection icons when used with a video display, during the play of the bonus round. The benefit of the mechanical scrolling mechanism in this example is that it appeals to the traditional mechanical slot machine player and is likely to be associated with a mechanical reel slot game. The limitation is in the amount of information that can be presented and the amount of information that can be stored until needed is less in the mechanical scrolling mechanism than in a video display. The number of pay tables that can be displayed is limited to the amount of scrolling media stored in the rollers of the mechanism. Depending on the size of the display area, this can be as few as two views but is more likely to be from 3 to 5 views. The benefit of the mechanical scrolling mechanism being mimicked on a video display is that it allows for more entertaining features to be added and it is more likely to appeal to a younger, computer graphics-savvy generation. It also allows more information to be conveyed to the player on any single view and has the potential of storing a vast amount of displays and variable views depending on the needs of the game. In the above example, any number of pay tables or bonus features can be displayed during play of the bonus round and the only limitation is the amount of memory present in the hardware that processes the game.

Each of these embodiments and obvious variations thereof is contemplated as falling within the spirit and scope of the claimed invention, which is set forth in the following claims.

What is claimed is:

1. A gaming machine for conducting a wagering game, comprising:
a game display for displaying the wagering game; and
an alterable signage display portraying a mechanical display member movable between a first position and a second position, the display member displaying first and second signage information to a player when in the respective first and second positions, the signage information being free of random events and outcomes associated with the wagering game.

2. The machine of claim 1, wherein the signage information is selected from a group consisting of billboard information, advertisement information, player attraction material, pay table information, bonusing information, game help information, game play instructions, and thematic artwork.

3. The machine of claim 1, wherein the wagering game is selected from a group consisting of reel slots, poker, keno, bingo, blackjack, and roulette.

4. The machine of claim 1, wherein the gaming machine includes a processor for executing the wagering game and operating, at least indirectly, the signage display.

5. The machine of claim 1, wherein the signage display is a video display.

6. The machine of claim 5, wherein the signage display portrays the mechanical display member to include a scrolling media that appears to scroll between the first and second positions.

7. The machine of claim 5, wherein the signage display portrays the mechanical display member to include a panel that appears to rotate about an axis between the first and second positions, the panel displaying first and second sides to the player when in the respective first and second positions, the first and second signage information being displayed on the respective first and second sides of the panel.

8. The machine of claim 5, wherein the signage display portrays the mechanical display member to include a plurality of panels that appear to rotate about respective axes between the first and second positions, each of the panels displaying first and second sides to the player when in the respective first and second positions, the first and second signage information being displayed on the respective first and second sides of the panels.

9. The machine of claim 1, wherein the game display is selected from a group consisting of a mechanical reel spinning display and a video display.

10. The machine of claim 1, further including a cabinet and a top box mounted on top of the cabinet, the game display being mounted within the cabinet, the signage display being mounted within the top box.

11. The machine of claim 1, wherein the wagering game includes a basic game and a bonus event, the bonus event being triggered by a start-bonus outcome in the basic game, wherein the display member displays the first signage information during the basic game and the second signage information during the bonus game.

12. A method of operating a gaming machine, the gaming machine including a game display and an alterable signage display, the signage display portraying a mechanical display member movable between a first position and a second position the method comprising:
displaying a wagering game on the game display;
portraying the display member in a first position to display first signage information to a player; and
portraying movement of the display member to a second position to display second signage information to the player, the first and second signage information being free of random events and outcomes associated with the wagering game.

13. The method of claim 12, wherein the signage information is selected from a group consisting of billboard information, advertisement information, player attraction material, pay table information, bonusing information, game help information, game play instructions, and thematic artwork.

14. The method of claim 12, wherein the wagering game is selected from a group consisting of reel slots, poker, keno, bingo, blackjack, and roulette.

15. The method of claim 12, further including using a processor to execute the wagering game and operate, at least indirectly, the signage display.

16. The method of claim 12, wherein the signage display is a video display.

17. The method of claim 16, wherein the signage display portrays the mechanical display member to include a scrolling media that appears to scroll between the first and second positions, wherein the step of portraying movement includes portraying scrolling of the media to the second position.

18. The method of claim 16, wherein the signage display portrays the mechanical display member to include a panel that has first and second sides and appears to rotate about an axis between the first and second positions, wherein the step of portraying movement includes portraying rotation of the panel to display a different one of the sides of the panel to the player.

19. The method of claim 16, wherein the signage display portrays the mechanical display member to include a plurality of panels that each have first and second sides and appear to rotate about a respective axis between the first and second positions, wherein the step of portraying movement includes portraying rotation of each panel to display a different one of the sides of the panel to the player.

20. The method of claim 12, wherein the game display is selected from a group consisting of a mechanical reel spinning display and a video display.

21. The method of claim 12, further including a cabinet and a top box mounted on top of the cabinet, the game display being mounted within the cabinet, the signage display being mounted within the top box.

22. The method of claim 12, wherein the wagering game includes a basic game and a bonus event, the bonus event being triggered by a start-bonus outcome in the basic game, wherein the display member displays the first signage information during the basic game and the second signage information during the bonus game.

23. A gaming machine for conducting a wagering game, comprising:
a game display for displaying the wagering game; and
a signage display portraying a flexible display member that appears to scroll between a first position and a second position, the display member displaying first and second signage information to a player when in the respective first and second positions, the signage information being free of random events and outcomes associated with the wagering game.

24. The machine of claim 23, wherein the signage display is a video display.
